(19) United States
(12) Patent Application Publication
(10) Pub. No.: US 2015/0248822 A1
(43) Pub. Date: Sep. 3, 2015

(54) SLOT MACHINE

(71) Applicant: OMORN CORPORATION, Kyoto-shi, Kyoto (JP)

(72) Inventor: Ryoji Okazaki, Aichi (JP)

(73) Assignee: OMRON Corporation, Kyoto-shi, Kyoto (JP)

(21) Appl. No.: 14/435,993

(22) PCT Filed: Sep. 10, 2013
(86) PCT No.: PCT/JP2013/005357

§ 371 Date: Apr. 15, 2015

(30) Foreign Application Priority Data
Nov. 22, 2012 (JP) 2012-256806

(51) Int. Cl. G07F 17/34; G07F 17/32

(52) U.S. Cl. CPC G07F 17/34; G07F 17/3213

(57) ABSTRACT

A slot machine has a selection target item presenting part that presents, as a selection target item, any one of a plurality of items, each of which indicates a combination of a numbers of bets and a number of lines, a switching-instruction receiving part that receives an instruction to switch the selection target item, from among the plurality of items, to be presented on the selection target item presenting part, and a setting-instruction receiving part that receives an instruction to set, as a game condition, a number of bets and a number of lines that correspond to an item being presented as the selection target item on the selection target item presenting part.

### CROSS-REFERENCE TO RELATED APPLICATIONS

The present application is a national stage application of PCT/JP2013/005357, filed on Sep. 10, 2013, which claims priority from Japanese Patent Application No. 2012-256806, filed on Nov. 22, 2012, the contents of which are incorporated herein in their entirety.

### BACKGROUND

1. Technical Field

The present invention relates to a slot machine

2. Related Art

Patent Literature 1 discloses a liquid crystal operation button for changing, according to a software program, characters, patterns, the number of bets or the number of lines that are to be displayed on a liquid crystal display apparatus and required for game operations. Because such a liquid crystal operation button makes it possible to change operation contents to be allocated to the liquid crystal button, the number of liquid crystal buttons can be reduced, and the installation space of the liquid crystal button can be reduced.

[Patent Literature 1] Japanese Patent Application Publication No. 2008-54696

### SUMMARY

However, it is desired to further reduce the installation space of an operation unit such as a button provided to a slot machine.

A slot machine according to one or more embodiments of the present invention comprises: a selection target item presenting part that presents, as a selection target item, any one of a plurality of items that each indicate a combination of a numbers of bets and a number of lines; a switching-instruction receiving part that receives an instruction to switch the selection target item, from among the plurality of items, to be presented on the selection target item presenting part; and a setting-instruction receiving part that receives an instruction to set, as a game condition, a number of bets and a number of lines that correspond to an item being presented as the selection target item on the selection target item presenting part.

In the above-described slot machine, the selection target item presenting part may present the selection target item by displaying an image including a selection target item object that indicates the selection target item, the setting-instruction receiving part may be a push-button switch, and the push-button switch may be provided above a display area of the selection target item object, and make visible the selection target item object through a pressing surface of the push-button switch.

In the above-described slot machine, the plurality of items may be respectively associated with a presentation order in advance, the switching-instruction receiving part may have: an ascending order-switching-instruction receiving part that receives an ascending order-switching-instruction to switch the selection target item, from among the plurality of items, to be presented on the selection target item presenting part in an ascending order; and a descending order-switching-instruction receiving part that receives a descending order-switching-instruction to switch the selection target item, from among the plurality of items, to be presented on the selection target item presenting part in a descending order.

In the above-described slot machine, the plurality of items may be respectively associated with a presentation order in advance, the switching-instruction receiving part may have: an ascending order-switching-instruction receiving push-button switch that receives an ascending order-switching-instruction to switch the selection target item, from among the plurality of items, to be presented on the selection target item presenting part in an ascending order; and a descending order-switching-instruction receiving push-button switch that receives a descending order-switching-instruction to switch the selection target item, from among the plurality of items, to be presented on the selection target item presenting part in a descending order, the slot machine further may comprise: an ascending order object display part that displays an image including an ascending order object that indicates the ascending order-switching-instruction; and a descending order object display part that displays an image including a descending order object that indicates the descending order-switching-instruction, the ascending order-switching-instruction receiving push-button switch may be provided above a display area of the ascending order object, and make visible the ascending order object through a pressing surface of the ascending order-switching-instruction receiving push-button switch, and the descending order-switching-instruction receiving push-button switch may be provided above a display area of the descending order object, and make visible the descending order object through a pressing surface of the descending order-switching-instruction receiving push-button switch.

In the above-described slot machine, the push-button switch that is the setting-instruction receiving part may be provided between the ascending order-switching-instruction receiving push-button switch and the descending order-switching-instruction receiving push-button switch.

In the above-described slot machine, the selection target item presenting part, the ascending order object display part, and the descending order object display part may be configured with a single display unit, and the display unit may display an image including the selection target item object, the ascending order object, and the descending order object.

The summary does not describe all embodiments of the present invention. Embodiments of the present invention also may include sub-combinations of the features described above and other aspects that will be apparent to those of skill in the art from the detailed description.

### BRIEF DESCRIPTION OF THE DRAWINGS

FIG. 1 is one example of an external perspective view of the slot machine according to one or more embodiments of the present invention.

FIG. 2 is a figure that illustrates functional blocks of an operation unit.

FIG. 3 is an external perspective view of an operation unit.

FIG. 4 is a figure that illustrates one example of objects that are made visible through a pressing surface of a push-button switch.

FIG. 5 is a figure that illustrates one example of an image that is displayed on a display part of a slot machine.

FIG. 6 is a figure that illustrates another example of objects that are made visible through a pressing surface of a push-button switch.

FIG. 7 is a figure that illustrates another example of an image that is displayed on a display part of a slot machine.

FIG. 8 is an exploded perspective view of an operation unit.

FIG. 9 is a perspective view of an operation unit, illustrating a cross section of a part thereof.

FIG. 10 is an external perspective view of a push-button switch.

FIG. 11 is an external perspective view of a rubber sheet.

FIG. 12 is an external perspective view of a base plate.

FIG. 13 is an external perspective view of a spectral wall.

FIG. 14 is an external perspective view of a diffusion rotary body.

FIG. 15 is an external perspective view of a gear.

FIG. 16 is a front view of an operation surface of an operation unit.

FIG. 17 is a sectional view taken along the line A-A illustrated in FIG. 11.

FIG. 18 is a sectional view taken along the line B-B illustrated in FIG. 11.

FIG. 19 is a sectional view taken along the line C-C illustrated in FIG. 11.

### DETAILED DESCRIPTION

Hereinafter, embodiments of the present invention will be described. The below embodiments do not limit the invention, and all the combinations of the features described above are not required by the claims. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

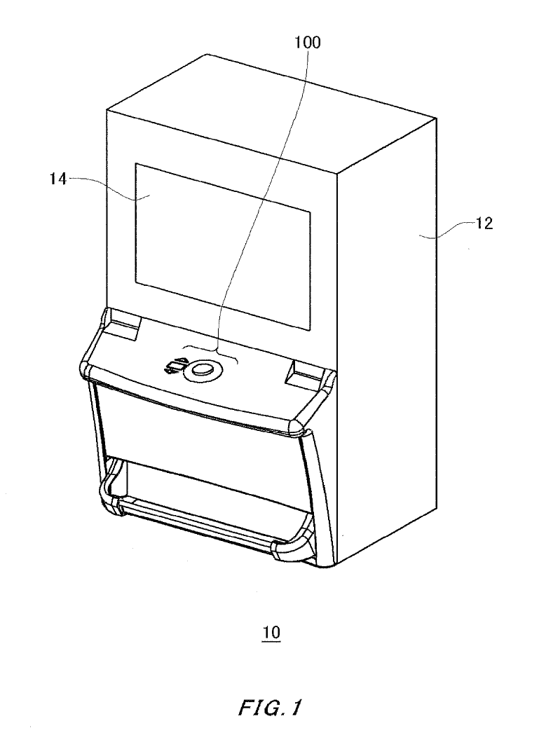

FIG. 1 is one example of an external perspective view of a slot machine 10 according to one or more embodiments of the present invention. The slot machine 10 comprises a main body 12, a display part 14, and an operation unit 100. The slot machine 10 is one example of game machines, and the operation unit 100 can be mounted on another game machine such as a rotary drum type game machine.

The display part 14 displays game images including a plurality of reels indicating multiple types of patterns, winning lines that define combinations of patterns, and the number of bets that indicate a money amount betted on winning lines. Other than primary games of game machines, the display part 14 may display images about a so-called mini game that is started under predetermined conditions during the games.

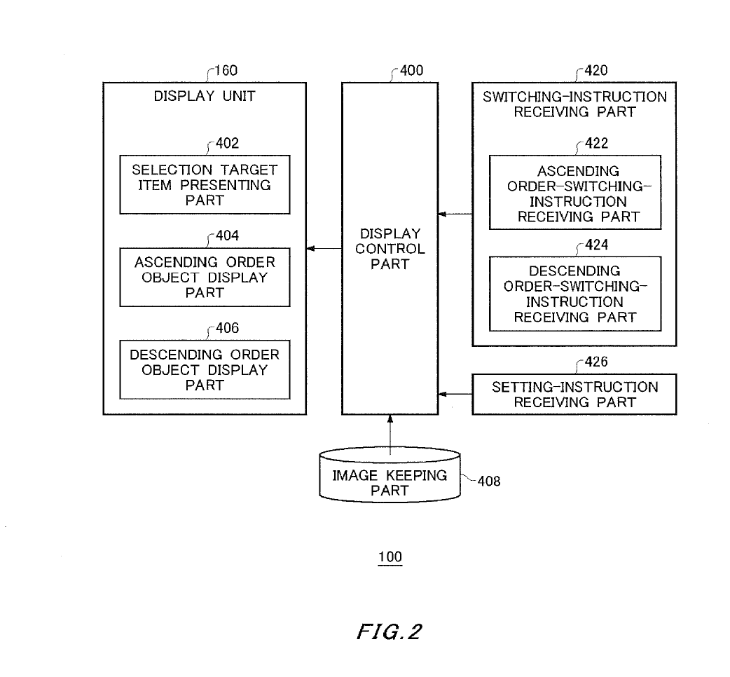

FIG. 2 is a figure that illustrates functional blocks of the operation unit 100. The operation unit 100 comprises a display unit 160, a display control part 400, an image keeping part 408, a switching-instruction receiving part 420, and a setting-instruction receiving part 426.

The image keeping part 408 keeps images to be displayed on the display unit 160. The display control part 400 controls display of the display unit 160.

The display unit 160 has a selection target item presenting part 402, an ascending order object display part 404, and a descending order object display part 406. The selection target item presenting part 402 presents to a player, as a selection target item, any one of a plurality of items that indicate combinations of the numbers of bets that indicate betted money amounts, and the numbers of lines that indicate numbers of winning lines. The selection target item presenting part 402 may present to a player a selection target item by displaying an image including a selection target item object that indicates a selection target item. The plurality of items are respectively associated with a presentation order in advance.

The switching-instruction receiving part 420 receives, from a player, an instruction to switch a selection target item, from among the plurality of items, to be presented on the selection target item presenting part 402. The switching-instruction receiving part 420 has an ascending order-switching-instruction receiving part 422 and a descending order-switching-instruction receiving part 424. The ascending order-switching-instruction receiving part 422 receives, from a player, an ascending order-switching-instruction to switch a selection target item, from among a plurality of items, to be presented on the selection target item presenting part 402 in an ascending order. The descending order-switching-instruction receiving part 424 receives, from a player, a descending order-switching-instruction to switch a selection target item, from among a plurality of items, to be presented on the selection target item presenting part 402 in a descending order.

The ascending order-switching-instruction receiving part 422 may be an ascending order-switching-instruction receiving push-button switch that receives an ascending order-switching-instruction to switch a selection target item, from among a plurality of items, to be presented on the selection target item presenting part 402 in an ascending order. Also, the descending order-switching-instruction receiving part 424 may be a descending order-switching-instruction receiving push-button switch that receives a descending order-switching-instruction to switch a selection target item, from among a plurality of items, to be presented on the selection target item presenting part 402 in a descending order.

The display unit 160 further has the ascending order object display part 404 and the descending order object display part 406. The ascending order object display part 404 displays an image including an ascending order object that indicates an ascending order-switching-instruction. The descending order object display part 406 displays an image including a descending order object that indicates a descending order-switching-instruction.

The ascending order-switching-instruction receiving push-button switch may be provided above a display area of an ascending order object, and make visible an ascending order object through a pressing surface of the ascending order-switching-instruction receiving push-button switch. Also, the descending order-switching-instruction receiving push-button switch may be provided above a display area of the descending order object, and make visible a descending order object through a pressing surface of the descending order-switching-instruction receiving push-button switch.

The setting-instruction receiving part 426 receives, from a player, an instruction to set, as a game condition, a number of bets and a number of lines that correspond to an item being presented as a selection target item on the selection target item presenting part 402. The setting-instruction receiving part 426 may be a push-button switch. The push-button switch may be provided above a display area of the selection target item object, and make visible a selection target item object through a pressing surface of the push-button switch.

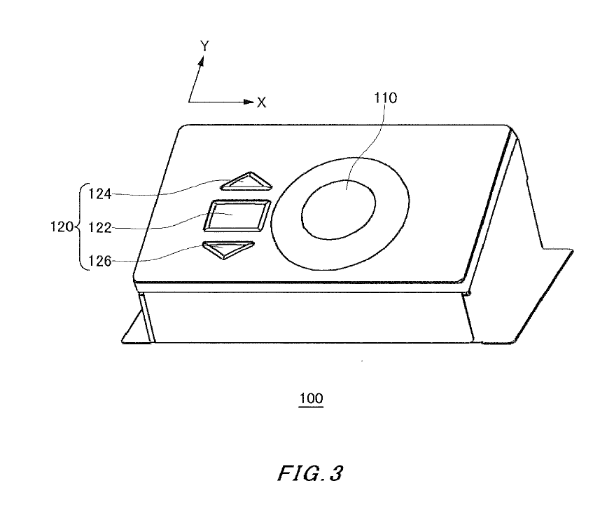

FIG. 3 is one example of an external perspective view of the operation unit 100 according to one or more embodiments of the present invention. The operation unit 100 comprises a push-button switch 110 and a push-button switch set 120. The push-button switch set 120 is placed adjacent to the push-button switch 110 in the X-axis direction. The push-button switch set 120 includes a push-button switch 122, a push-button switch 124, and a push-button switch 126. The push-button switch 122, the push-button switch 124, and the push-button switch 126 are placed in one line along the Y-axis direction. The push-button switch 122 is placed between the push-button switch 124 and the push-button switch 126.

The push-button switch 110 is for example a push-button switch that has a round pressing surface, and outputs an instruction about rotation of a reel. The push-button switch 122 is one example of the setting-instruction receiving part 426, and is for example a push-button switch that has a rectangular pressing surface, and receives, from a player, an instruction corresponding to one selection target item that is presented from among a plurality of items. The push-button switch 124 is one example of an ascending order-switching-instruction receiving push-button switch, and is a push-button switch that has a triangular pressing surface, and outputs an instruction to switch, in an ascending order, an item to be presented as a selection target item from among a plurality of items which are associated in advance with a presentation order. The push-button switch 126 is one example of a descending order-switching-instruction receiving push-button switch, and is a push-button switch that has a triangular pressing surface, and outputs an instruction to switch, in a descending order, an item to be presented as a selection target item from among a plurality of items which are associated in advance with a presentation order.

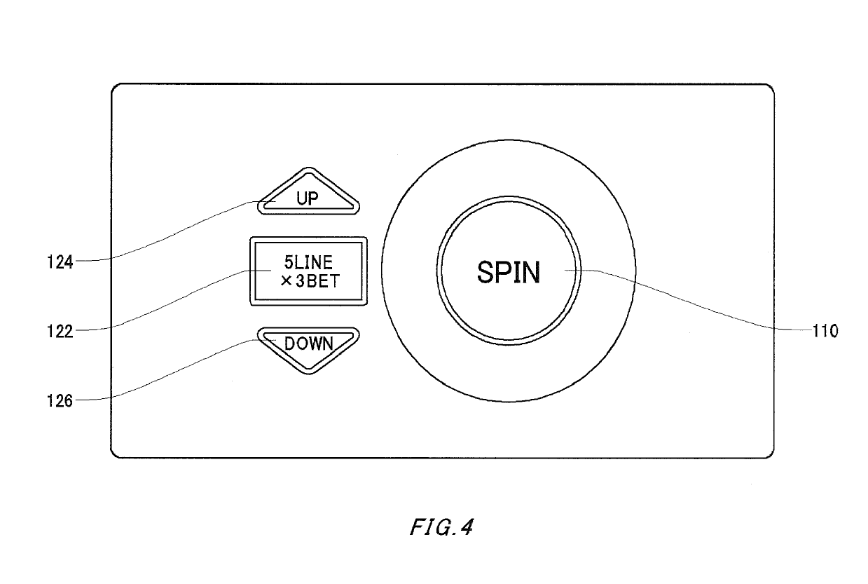

FIG. 4 illustrates one example of objects that are made visible through the pressing surfaces of the push-button switch 110, the push-button switch 122, the push-button switch 124, and the push-button switch 126.

The display unit 160 displays, at a position that corresponds to the pressing surface of the push-button switch 110, an operation image including an object including text “SPIN” indicating an instruction to rotate a reel. The display unit 160 that functions as the selection target item presenting part 402 displays, at a position that corresponds to the pressing surface of the push-button switch 122, an operation image further including a selection target item object that should present, as a selection target item, any one of a plurality of items that indicate combinations of the numbers of bets that indicate betted money amounts, and the numbers of lines of winning lines. Note that an object displayed by the display unit 160 that indicates a combination of the number of lines and the number of bets is memorized in a memory in advance for each combination of the number of lines and the number of bets. A plurality of items that indicate combinations of the numbers of bets that indicate betted money amounts and the numbers of lines of winning lines are respectively associated in advance with a presentation order.

When the push-button switch 122 is pressed, a combination of the number of bets and the number of lines that is being displayed, as the selection target item object, at a position that corresponds to the pressing surface of the push-button switch 122 is set as a game condition, and a game is performed.

The display unit 160 that functions as the ascending order object display part 404 displays, at a position that corresponds to the pressing surface of the push-button switch 124, an operation image further including an ascending order object including text “UP” that indicates switching of selection target item objects in an ascending order. In addition, the display unit 160 that functions as the descending order object display part 406 displays, at a position that corresponds to the pressing surface of the push-button switch 126, an operation image further including a descending order object including text “DOWN” that indicates switching of selection target item objects in a descending order.

As described above, by assigning a combination of the number of lines and the number of bets to one push-button switch, the number of push-button switches can reduced as compared with a case where a push-button switch for setting the number of lines and a push-button switch for setting the number of bets are provided separately. Also, by switching combinations of the numbers of lines and the numbers of bets assigned to a push-button switch by the push-button switch, the number of push-button switches can be reduced as compared with a case where push-button switches are provided separately for respective combinations of the numbers of lines and the numbers of bets. Thereby, the installation space of push-button switches can be reduced significantly.

When the space for adding an operation button and the like is small, for example, the display part 14 that is a main screen of a slot machine may be configured with a touch panel display, and the display part 14 may be allowed to function as an operation unit having another function. However, some players cannot reach for the display part 14 that is a main screen of a slot machine, or may feel it is bothersome to perform touch operation by using a touch panel display. Because the operation unit 100 according to one or more embodiments of the present invention allows installation within a relatively small space, it is easy to install the operation unit 100 on an operation board that is originally provided to the main body 12 of the slot machine 10. Therefore, it is possible to easily install the operation unit 100 in which a plurality of operation functions are integrated, at a location that allows easy operation even for a player who does not prefer the above-mentioned touch panel display.

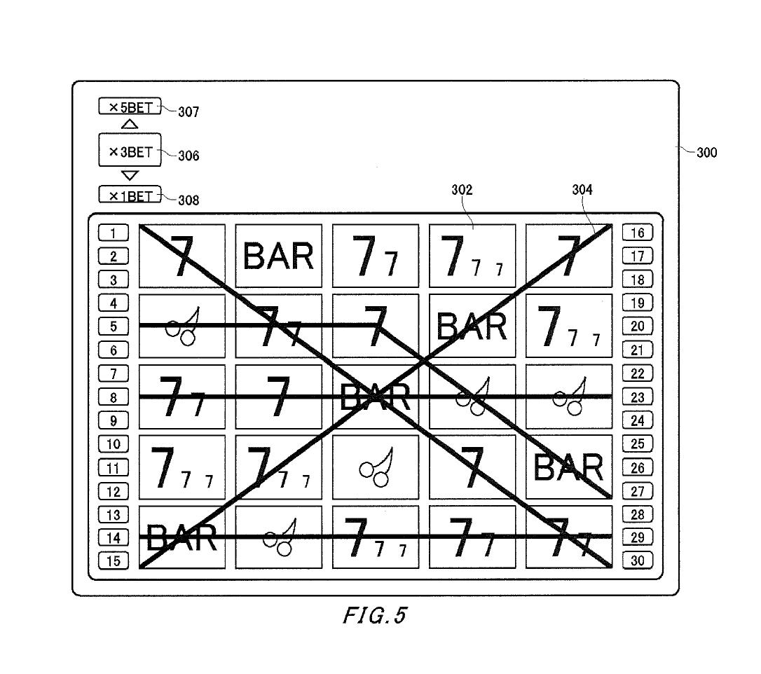

FIG. 5 illustrates one example of an image 300 displayed on the display part 14 provided in the main body 12 of the slot machine 10. The image 300 includes: reels 302 that indicate a plurality of patterns; winning lines 304 being set; a number of bets 306 being set; a number of bets 307 on an ascending order side that indicates the number of bets to be displayed next when the combination of the number of lines and the number of bets is switched in an ascending order by the push-button switch 124; and a number of bets 308 on a descending order side that indicates the number of bets to be displayed next when the combination of the number of lines and the number of bets is switched in a descending order by the push-button switch 126.

Every time the combination of the number of lines and the number of bets to be presented as a selection target item is switched by the push-button switch 124 or the push-button switch 126, the lines of the winning lines 304 and the numbers of bets of the numbers of bets 306, 307, and 308 that are displayed in the image 300 are switched.

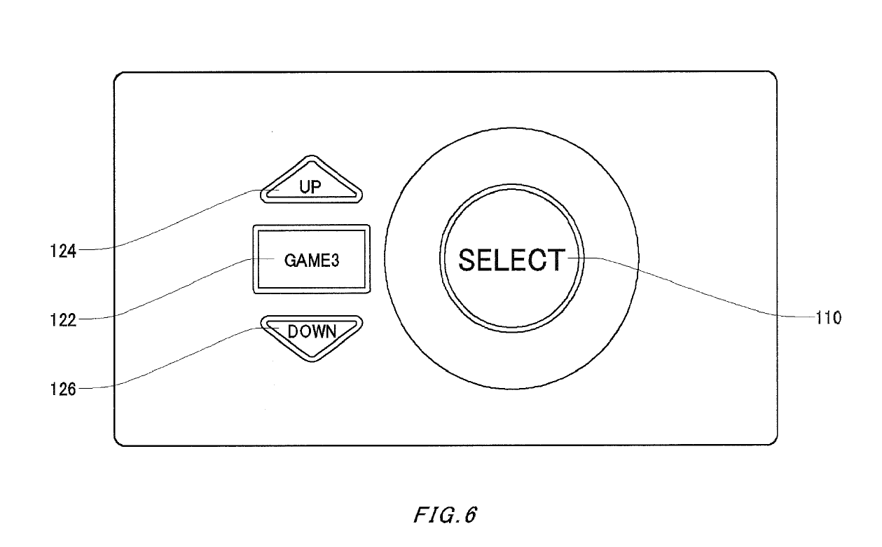

FIG. 6 illustrates another one example of objects that are made visible through the pressing surfaces of the push-button switch 110, the push-button switch 122, the push-button switch 124, and the push-button switch 126.

The display unit 160 may display, at a position that corresponds to the pressing surface of the push-button switch 122, an operation image that includes, as a selection target item object, an item that corresponds to any one mini game from among a plurality of items that correspond to a plurality of mini games that can be selected under predetermined conditions during a game. The plurality of items that correspond to the plurality of selectable mini games are respectively associated with a presentation order.

The display unit 160 that functions as the ascending order object display part 404 displays, at a position that corresponds to the pressing surface of the push-button switch 124, an operation image further including an ascending order object including text “UP” that indicates switching of selection target item objects in an ascending order. In addition, the display unit 160 that functions as the descending order object display part 406 displays, at a position that corresponds, to the pressing surface of the push-button switch 126, an operation image further including a descending order object including text “DOWN” that indicates switching of selection target item objects in a descending order.

The display unit 160 displays, at a position that corresponds to the pressing surface of the push-button switch 110, an operation image further including an object including text “SELECT” that indicates an instruction to select a mini game that corresponds to a selection target item object. When the push-button switch 110 is pressed, a mini game that corresponds to a selection target item object displayed at a position that corresponds to the pressing surface of the push-button switch 122 is started. Note that when the push-button switch 122 is pressed, a mini game that corresponds to a selection target item object displayed at a position that corresponds to the pressing surface of the push-button switch 122 may be started.

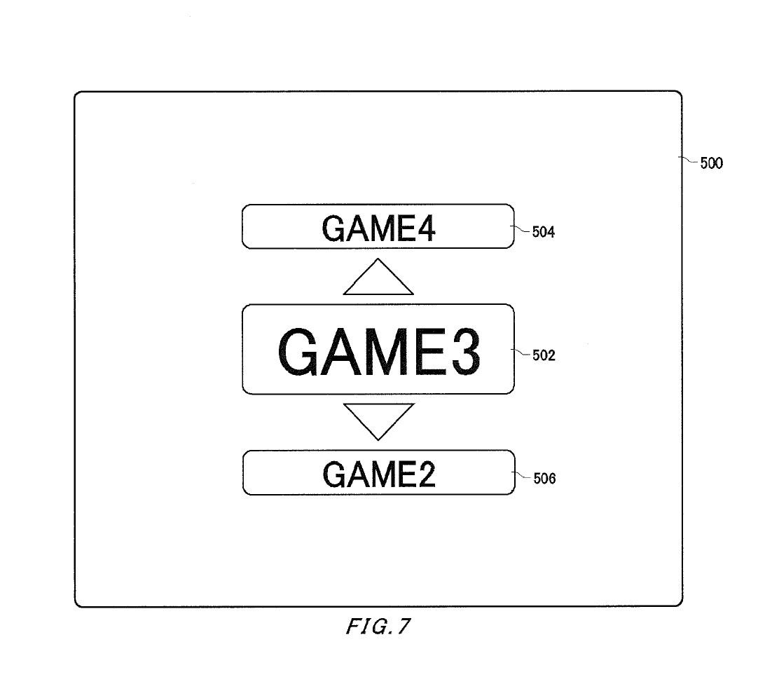

FIG. 7 illustrates another one example of an image 500 displayed on the display part 14 that is provided to the main body 12 of the slot machine 10 when a mini game is selected via the operation unit 100. An object 502 that indicates a type of a mini game displayed as a selection target item, an object 504 that indicates a type of a mini game to be displayed next as a selection target item when the push-button switch 124 is pressed, and an object 506 that indicates a type of a mini game to be displayed next as a selection target item when the push-button switch 126 is pressed may be displayed on the display part 14.

As described above, by displaying one image including objects that indicate respective functions of push-button switches on the single display unit 160, it becomes unnecessary to synchronize respective display units as in a case where display units are prepared for respective push-button switches. Also, the cost can be reduced as compared with a case where the operation unit 100 comprises a plurality of display units.

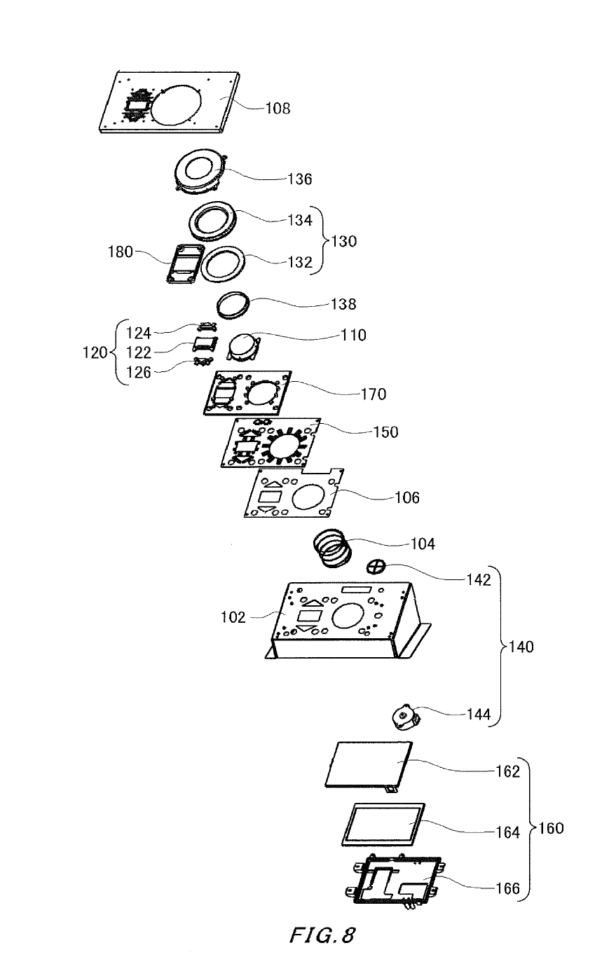

FIG. 8 illustrates an exploded perspective view of the operation unit 100. The operation unit 100 comprises the display unit 160, a rotary mechanism 140, a bracket 102, a spring 104, an insulation sheet 106, a base plate 150, a rubber sheet 170, the push-button switch 110, the push-button switch set 120, a bush 138, a diffusion unit 130, a spectral wall 180, a diffusion unit cover 136, and an operation unit cover 108.

The display unit 160 has a liquid crystal display (LCD) 164, an LCD cover 162, and an LCD case 166. The LCD 164 is housed in the LCD case 166, and is covered with the transparent LCD cover 162.

The rotary mechanism 140 has a motor 144 and a gear 142. The gear 142 is rotated by the motor 144. The diffusion unit 130 has a diffuser panel 132 and a diffusion rotary body 134. The diffusion unit 130 is rotated by the rotary mechanism 140.

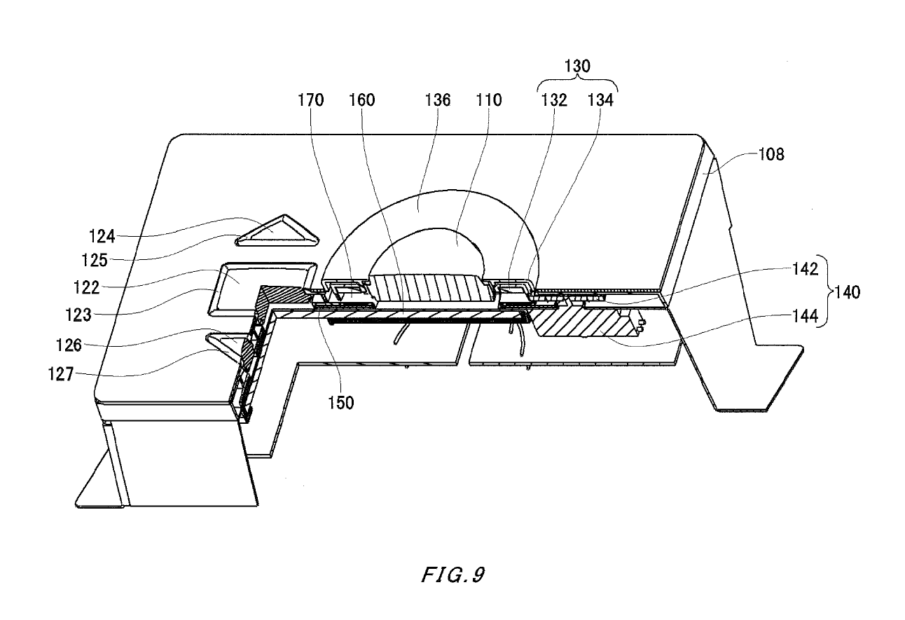

FIG. 9 is a perspective view of the operation unit 100, illustrating a cross section of a part thereof. The operation unit 100 comprises therein the display unit 160.

The display unit 160 is placed below the push-button switch 110, the push-button switch 122, the push-button switch 124, and the push-button switch 126. The push-button switch 110, the push-button switch 122, the push-button switch 124, and the push-button switch 126 make visible, through their pressing surfaces, parts of an image being displayed on the display unit 160. The display unit 160 displays an operation image including, in areas that correspond to respective positions of the push-button switch 110, the push-button switch 122, the push-button switch 124, and the push-button switch 126, respective objects such as text and graphics that correspond to respective functions of the push-button switch 110, the push-button switch 122, the push-button switch 124, and the push-button switch 126.

The push-button switch 110, the push-button switch 122, the push-button switch 124, and the push-button switch 126 are each provided above display areas of objects that correspond to their respective functions within the display area of the display unit 160, and make visible, through their pressing surfaces, the objects that correspond to their respective functions.

The push-button switch 110, the push-button switch 122, the push-button switch 124, and the push-button switch 126 have been subjected to solid immersion lens processing, respectively, magnify a partial image of an image being displayed on the display unit 160, and make visible the partial image through their pressing surfaces. Thereby, depth feel of an image visible through the pressing surfaces can be removed.

The diffusion unit 130 has a through-hole. That is, the diffuser panel 132 and the diffusion rotary body 134 have through-holes at mutually facing positions. The push-button switch 110 is placed inside the through-hole of the diffusion unit 130. The diffusion unit cover 136 is configured with a half mirror, and covers the diffusion unit 130 from above. The diffuser panel 132 diffuses light that is incident from an LED provided to the base plate 150, and outputs light from a periphery of the push-button switch 110 through the diffusion rotary body 134 and the diffusion unit cover 136. The LED is one example of a light-emitting element. Because the diffusion unit cover 136 is configured with a half mirror, the base plate 150 and the like inside the operation unit 100 are not visible through the diffusion unit cover 136 when the LED is not radiating light. Thereby, the decorativeness can be improved.

The diffusion rotary body 134 is, at its side surface, in contact with the gear 142, and responding to rotation of the gear 142 by the motor 144, rotates about a rotation axis that passes through the through-hole of the diffusion unit 130. Because the diffuser panel 132 is configured integrally with the diffusion rotary body 134, the diffuser panel 132 rotates about the rotation axis responding to rotation of the diffusion rotary body 134. In this manner, because the diffuser panel 132 rotates, the decorative effect can be improved even if the number of light-emitting elements provided to the base plate 150 is small.

Also, illumination parts 123, 125, and 127 configured with a transparent or semi-transparent material are placed around the push-button switch 122, the push-button switch 124, and the push-button switch 126. The base plate 150 has a plurality of LEDs at positions that face the illumination parts 123, 125, and 127. The plurality of LEDs outputs light from peripheries of the push-button switch 122, the push-button switch 124, and the push-button switch 126 through the illumination parts 123, 125, and 127. Thereby, peripheries of the push-button switch 122, the push-button switch 124, and the push-button switch 126 can be decorated with light. Note that the illumination parts 123, 125, and 127 may be configured integrally with the operation unit cover 108.

The operation unit 100 comprises the rubber sheet 170 that is one example of an elastic sheet between the push-button switch 110, the push-button switch 122, the push-button switch 124, and the push-button switch 126, and the base plate 150. The push-button switch 110, the push-button switch 122, the push-button switch 124, and the push-button switch 126 are placed on the rubber sheet 170.

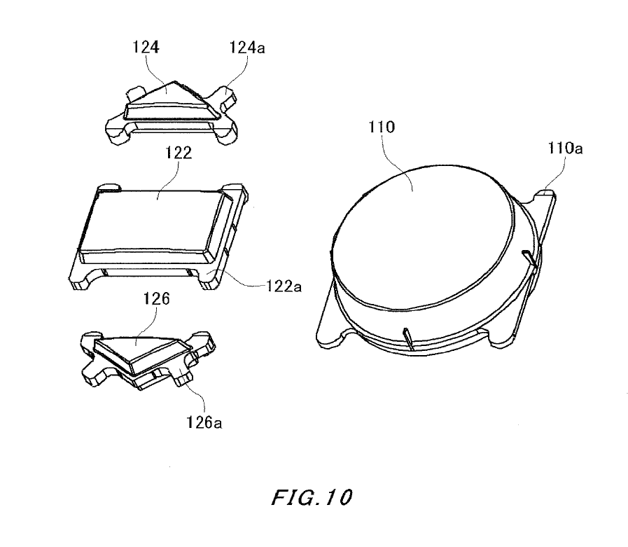

FIG. 10 is an external perspective view of the push-button switch 110, the push-button switch 122, the push-button switch 124, and the push-button switch 126. The push-button switch 110, the push-button switch 122, the push-button switch 124, and the push-button switch 126 have a plurality of leg parts 110a, 122a, 124a, and 126a supported on the rubber sheet 170.

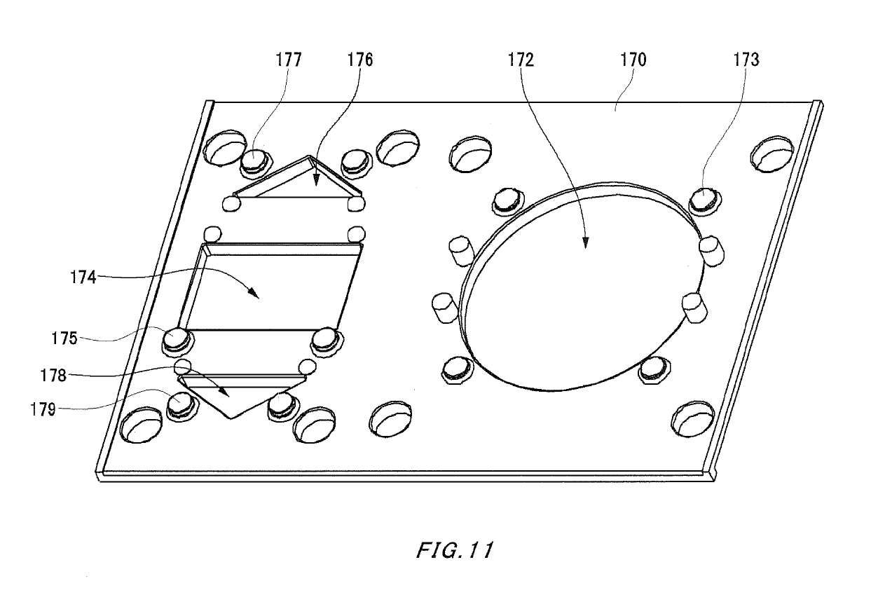

FIG. 11 illustrates an external perspective view of the rubber sheet 170. The rubber sheet 170 has through-holes 172, 174, 176, and 178 at positions that face the respective pressing surfaces of the push-button switch 110, the push-button switch 122, the push-button switch 124, and the push-button switch 126. The rubber sheet 170 has a plurality of protruding parts 173, 175, 177, and 179 at positions, around the through-holes 172, 174, 176, and 178, that face the plurality of leg parts 110a, 122a, 124a, and 126a.

The plurality of protruding parts 173, 175, 177, and 179 function as movable contacts, and when the push-button switch 110, the push-button switch 122, the push-button switch 124, and the push-button switch 126 are pressed, are pressed by the plurality of leg parts 110a, 122a, 124a, and 126a, and pushed to the base plate 150 side. The plurality of protruding parts 173, 175, 177, and 179 are elastic, and when the push-button switch 110, the push-button switch 122, the push-button switch 124, and the push-button switch 126 are no longer pressed, can return to the positions before being pushed.

Conductive layers such as carbon layers or metal layers are formed on surfaces of the plurality of protruding parts 173, 175, 177, and 179 on the base plate 150 side. When the push-button switch 110, the push-button switch 122, the push-button switch 124, and the push-button switch 126 are pressed, the conductive layers of the plurality of protruding parts 173, 175, 177, and 179 cause short circuits in opposite electrodes that configure fixed contacts on the base plate 150.

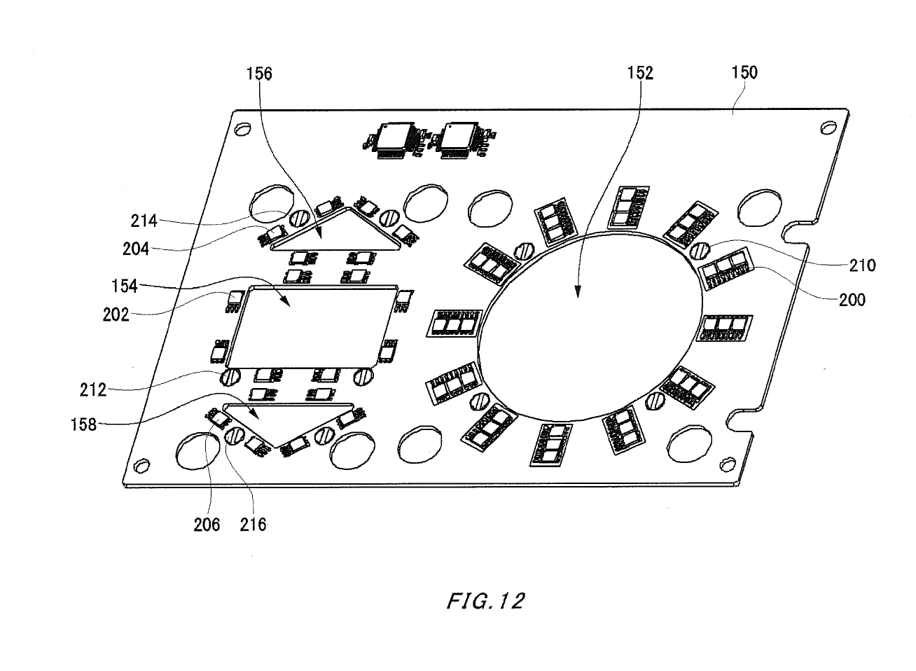

FIG. 12 illustrates an external perspective view of the base plate 150. The base plate 150 has through-holes 152, 154, 156, and 158 at positions that face the respective pressing surfaces of the push-button switch 110, the push-button switch 122, the push-button switch 124, and the push-button switch 126. The base plate 150 has a plurality of LEDs 200, 202, 204, and 206 that are placed at intervals along the outer circumference of the through-holes 152, 154, 156, and 158. The plurality of LEDs 200 outputs light from a periphery of the push-button switch 110 through the diffusion unit 130. The plurality of LEDs 202 outputs light from a periphery of the push-button switch 122 through the illumination part 123. The plurality of LEDs 204 outputs light from a periphery of the push-button switch 124 through the illumination part 125. The plurality of LEDs 206 outputs light from a periphery of the push-button switch 126 through the illumination part 127.

The base plate 150 has opposite electrodes 210, 212, 214, and 216 that are fixed contacts at positions that are between the plurality of LEDs 200, 202, 204, and 206, and face the plurality of protruding parts 173, 175, 177, and 179 provided to the rubber sheet 170. When the opposite electrodes 210, 212, 214, and 216 cause short circuits by being in contact with the conductive layers of the plurality of protruding parts 173, 175, 177, and 179, pressing of the push-button switch 110, the push-button switch 122, the push-button switch 124, and the push-button switch 126 is sensed.

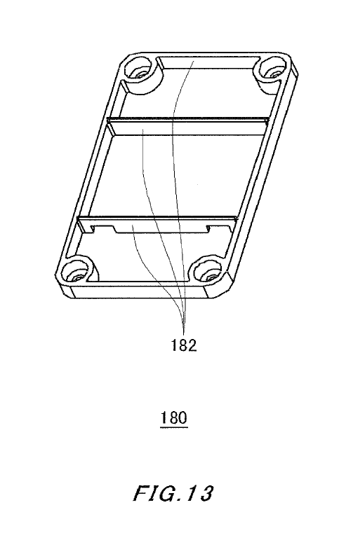

FIG. 13 is an external perspective view of the spectral wall 180. The spectral wall 180 has wall parts 182 that define the push-button switch 122, the push-button switch 124, and the push-button switch 126, and the wall parts 182 prevent light emitted by the LEDs 202, 204, and 206 that correspond respectively to the push-button switch 122, the push-button switch 124, and the push-button switch 126 from being output from a periphery of another non-corresponding push-button switch. Because the spectral wall 180 surrounds peripheries of the push-button switch 122, the push-button switch 124, and the push-button switch 126, only a periphery of a push-button switch that corresponds to an LED that is outputting light can be illuminated. Thereby, the decorativeness can be improved.

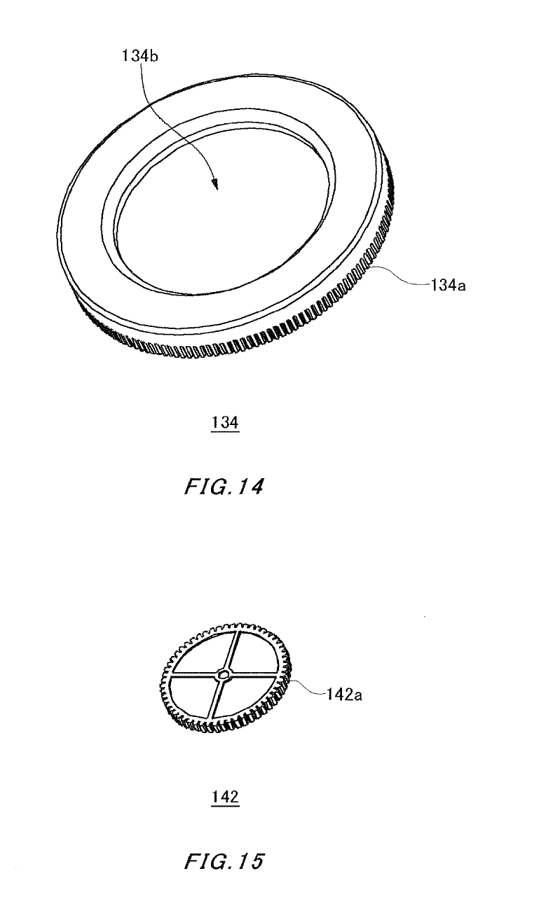

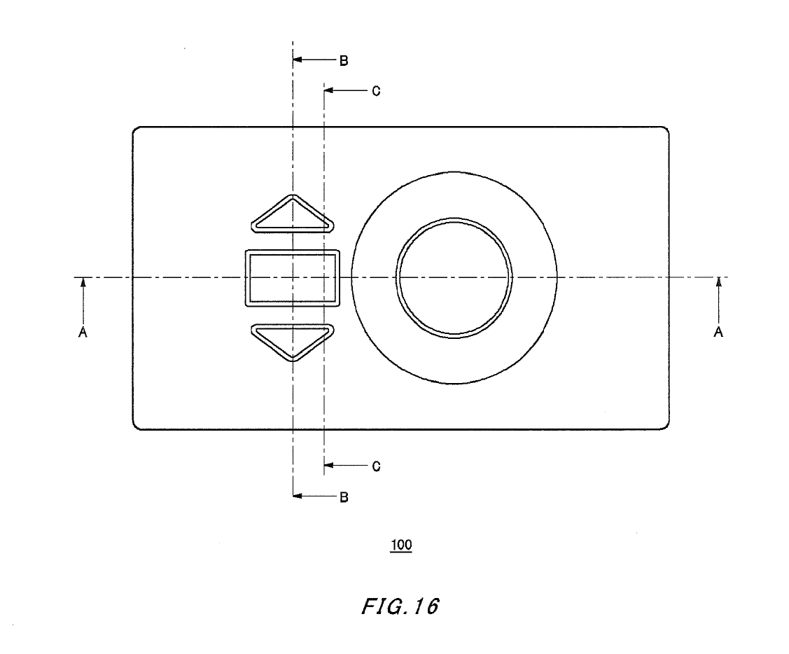

FIG. 14 illustrates an external perspective view of the diffusion rotary body 134. FIG. 15 illustrates an external perspective view of the gear 142. The diffusion rotary body 134 is a ring-shaped disk body, and has a plurality of teeth 134a on its outer circumference. The gear 142 has, on its outer circumference, a plurality of teeth 142a that gear the plurality of teeth 134a of the diffusion rotary body 134. Responding to rotation of the gear 142 by the motor 144, the plurality of teeth 134a of the diffusion rotary body 134 gear the plurality of teeth 142a of the gear 142, and the diffusion rotary body 134 rotates about a rotation axis that passes through the midpoint of a through-hole 134b.

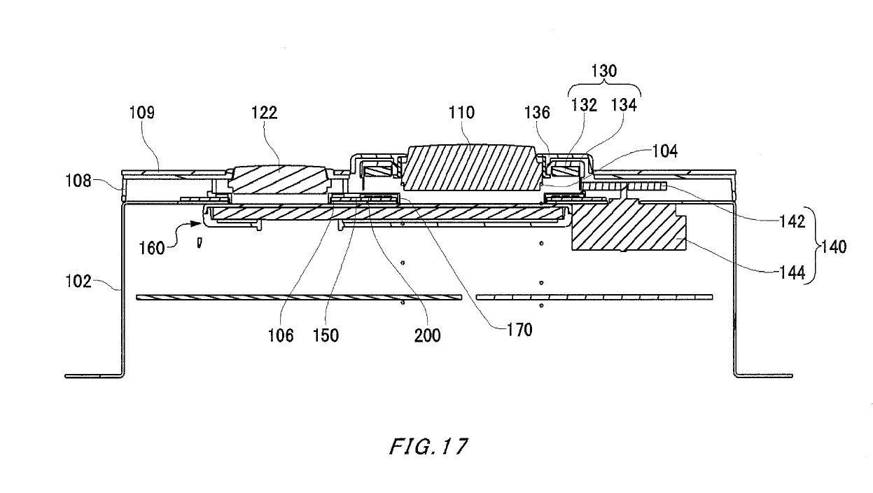

FIG. 16 illustrates a front view of an operation surface of the operation unit 100. FIG. 17 illustrates a sectional view taken along the line A-A illustrated in FIG. 16.

The display unit 160 is placed on the rear surface of the bracket 102. The bracket 102 has through-holes at positions that face the pressing surfaces of the push-button switch 110, the push-button switch 122, the push-button switch 124, and the push-button switch 126. The motor 144 is further placed on the rear surface of the bracket 102. The bracket 102 has another through-hole at a position that corresponds to a drive shaft of the motor 144.

The insulation sheet 106 is placed at a position, on the front surface of the bracket 102, that faces the display unit 160. The base plate 150 is placed on the insulation sheet 106. The rubber sheet 170 is placed on the base plate 150. The insulation sheet 106, the base plate 150, and the rubber sheet 170 have through-holes at positions that face the pressing surfaces of the push-button switch 110, the push-button switch 122, the push-button switch 124, and the push-button switch 126. The push-button switch 110, the push-button switch 122, the push-button switch 124, and the push-button switch 126 make visible, through their pressing surfaces, objects that correspond to their respective functions included in images being displayed on the display unit 160.

The push-button switch 110, the push-button switch 122, the push-button switch 124, and the push-button switch 126 are supported on the rubber sheet 170 via their respective leg parts. Also, the operation unit 100 further has the spring 104 inside through-holes formed at positions, of the bracket 102, the insulation sheet 106, the base plate 150, and the rubber sheet 170, that face the pressing surface of the push-button switch 110. The push-button switch 110 is supported also by the spring 104. The push-button switch 110 is larger in size than the push-button switch 122, the push-button switch 124, and the push-button switch 126. Also, because the push-button switch 110 functions as a push-button switch for instructing rotation of a reel, the push-button switch 110 is more frequently used than the push-button switch 122, the push-button switch 124, and the push-button switch 126. For this reason, it is possible that the push-button switch 110 does not, only with the elastic force of the rubber sheet 170, return to its original position after being pressed. To cope with this, by providing the spring 104, the elastic force of the spring 104 is added to the elastic force of the rubber sheet 170. Thereby, the push-button switch 110, after being pressed, can surely be returned to its original position.

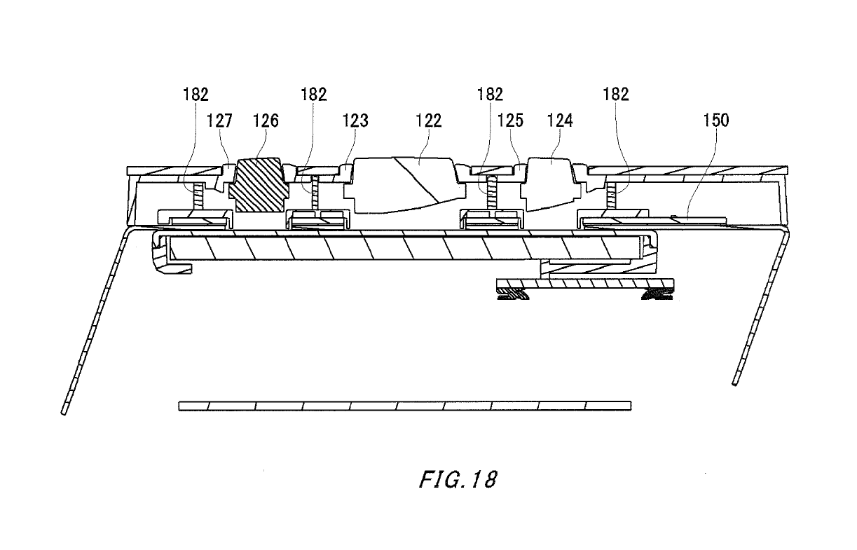

FIG. 18 illustrates a sectional view taken along the line B-B illustrated in FIG. 16. The push-button switch 122, the push-button switch 124, and the push-button switch 126 are placed in respectively separate spaces that are defined respectively by the wall parts 182 of the spectral wall 180. Accordingly, when an LED that corresponds to one push-button switch emits emit, light from the LED can be prevented from being incident onto a space of another push-button switch. Also, light reflected by the wall parts 182 is output externally via the illumination parts 123, 125, and 127 placed at upper parts of respective spaces. Thereby, a periphery of a corresponding push-button switch is illuminated with light.

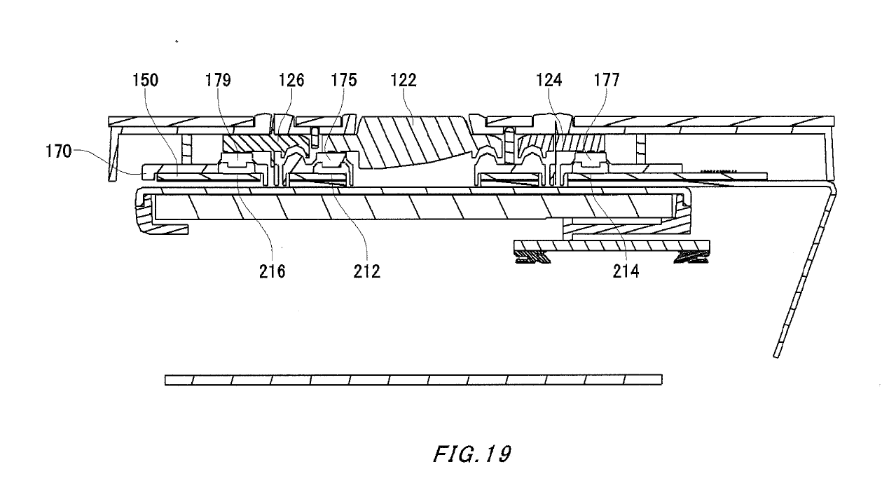

FIG. 19 illustrates a sectional view taken along the line C-C illustrated in FIG. 16. The push-button switch 122, the push-button switch 124, and the push-button switch 126 are supported, at their leg parts, by the protruding parts 175, 177, and 179 that are movable contacts on the rubber sheet 170. The base plate 150 has, at positions that face the protruding part 175, 177, and 179, the opposite electrodes 212, 214, and 216 that are fixed contacts. When the push-button switch 122, the push-button switch 124, and the push-button switch 126 are pressed, the protruding part 175, 177, and 179 are pushed to the base plate 150 side, and the protruding part 175, 177 and 179 come into contact with the opposite electrodes 212, 214, and 216. Thereby, the opposite electrodes 212, 214, and 216 are short-circuited, and pressing of the push-button switch 122, the push-button switch 124, and the push-button switch 126 can be sensed.

Note that, in one or more of the above embodiments, an example in which the ascending order-switching-instruction receiving part 422, the descending order-switching-instruction receiving part 424, and the setting-instruction receiving part 426 are respectively configured with push-button switches was explained. However, by configuring the display unit 160 with a touch panel display, the display unit 160 may be allowed to function as at least one of the ascending order-switching-instruction receiving part 422, the descending order-switching-instruction receiving part 424, and the setting-instruction receiving part 426. Thereby, the proportion of a display area that is allowed to function as an operation button relative to the display area of the display unit 160 can be made smaller.

While embodiments of the present invention are described above, the technical scope of the invention is not limited to the above described embodiments. It is apparent to persons skilled in the art that various alterations and improvements can be added to the above-described embodiments. The embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A slot machine comprising:
a selection target item presenting part that presents, as a selection target item, any one of a plurality of items, each of which indicates a combination of a numbers of bets and a number of lines;
a switching-instruction receiving part that receives an instruction to switch the selection target item, from among the plurality of items, to be presented on the selection target item presenting part; and
a setting-instruction receiving part that receives an instruction to set, as a game condition, a number of bets and a number of lines that correspond to an item being presented as the selection target item on the selection target item presenting part.

2. The slot machine according to claim 1,
wherein the selection target item presenting part presents the selection target item by displaying an image including a selection target item object that indicates the selection target item,
wherein the setting-instruction receiving part is a push-button switch, and
wherein the push-button switch is provided above a display area of the selection target item object, and makes visible the selection target item object through a pressing surface of the push-button switch.

3. The slot machine according to claim 1,
wherein the plurality of items are respectively associated with a presentation order in advance, and
wherein the switching-instruction receiving part comprises:
an ascending order-switching-instruction receiving part that receives an ascending order-switching-instruction to switch the selection target item, from among the plurality of items, to be presented on the selection target item presenting part in an ascending order; and
a descending order-switching-instruction receiving part that receives a descending order-switching-instruction to switch the selection target item, from among the plurality of items, to be presented on the selection target item presenting part in a descending order.

4. The slot machine according to claim 2,
wherein the plurality of items are respectively associated with a presentation order in advance,
wherein the switching-instruction receiving part comprises:
an ascending order-switching-instruction receiving push-button switch that receives an ascending order-switching-instruction to switch the selection target item, from among the plurality of items, to be presented on the selection target item presenting part in an ascending order; and
a descending order-switching-instruction receiving push-button switch that receives a descending order-switching-instruction to switch the selection target item, from among the plurality of items, to be presented on the selection target item presenting part in a descending order,
wherein the slot machine further comprises:
an ascending order object display part that displays an image including an ascending order object that indicates the ascending order-switching-instruction; and
a descending order object display part that displays an image including a descending order object that indicates the descending order-switching-instruction,
wherein the ascending order-switching-instruction receiving push-button switch is provided above a display area of the ascending order object, and makes visible the ascending order object through a pressing surface of the ascending order-switching-instruction receiving push-button switch, and
wherein the descending order-switching-instruction receiving push-button switch is provided above a display area of the descending order object, and makes visible the descending order object through a pressing surface of the descending order-switching-instruction receiving push-button switch.

5. The slot machine according to claim 4, wherein the push-button switch that is the setting-instruction receiving part is provided between the ascending order-switching-instruction receiving push-button switch and the descending order-switching-instruction receiving push-button switch.

6. The slot machine according to claim 4,
wherein the selection target item presenting part, the ascending order object display part, and the descending order object display part are configured with a single display unit, and
wherein the display unit displays an image including the selection target item object, the ascending order object, and the descending order object.

7. The slot machine according to claim 2,
wherein the plurality of items are respectively associated with a presentation order in advance, and
wherein the switching-instruction receiving part comprises:
an ascending order-switching-instruction receiving part that receives an ascending order-switching-instruction to switch the selection target item, from among the plurality of items, to be presented on the selection target item presenting part in an ascending order; and
a descending order-switching-instruction receiving part that receives a descending order-switching-instruction to switch the selection target item, from among the plurality of items, to be presented on the selection target item presenting part in a descending order.

8. The slot machine according to claim 7,
wherein the plurality of items are respectively associated with a presentation order in advance,
wherein the switching-instruction receiving part comprises:
an ascending order-switching-instruction receiving push-button switch that receives an ascending order-switching-instruction to switch the selection target item, from among the plurality of items, to be presented on the selection target item presenting part in an ascending order; and
a descending order-switching-instruction receiving push-button switch that receives a descending order-switching-instruction to switch the selection target item, from among the plurality of items, to be presented on the selection target item presenting part in a descending order,
wherein the slot machine further comprises:
an ascending order object display part that displays an image including an ascending order object that indicates the ascending order-switching-instruction; and
a descending order object display part that displays an image including a descending order object that indicates the descending order-switching-instruction,
wherein the ascending order-switching-instruction receiving push-button switch is provided above a display area of the ascending order object, and makes visible the ascending order object through a pressing surface of the ascending order-switching-instruction receiving push-button switch, and
wherein the descending order-switching-instruction receiving push-button switch is provided above a display area of the descending order object, and makes visible the descending order object through a pressing surface of the descending order-switching-instruction receiving push-button switch.

9. The slot machine according to claim 8, wherein the push-button switch that is the setting-instruction receiving part is provided between the ascending order-switching-instruction receiving push-button switch and the descending order-switching-instruction receiving push-button switch.

10. The slot machine according to claim 9,
wherein the selection target item presenting part, the ascending order object display part, and the descending order object display part are configured with a single display unit, and
wherein the display unit displays an image including the selection target item object, the ascending order object, and the descending order object.
